(19) United States
(12) Patent Application Publication
(10) Pub. No.: US 2003/0048737 A1
(43) Pub. Date: Mar. 13, 2003

(54) Optical pickup apparatus for recording and reading on information on recording media with optical-axis aligning means

(75) Inventors: Mizuki Nakamura, Iwata-gun (JP); Atsushi Kitamura, Iwata-gun (JP); Kozo Matsumoto, Iwata-gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 10/233,468

(22) Filed: Sep. 4, 2002

(30) Foreign Application Priority Data
Sep. 7, 2001 (JP) 2001-271761

(51) Int. Cl. G11B 7/135

(52) U.S. Cl. 369/112.19

(57) ABSTRACT

An optical pickup apparatus includes: one laser beam source for emitting two laser beams having respective optical paths parallel to each other and wavelengths different from each other; an optical-axis aligning means adapted to make the laser beams coaxial with each other; a collimating lens; a reflecting mirror; and an objective lens. A laser beam reflected at a high or low density disk takes the incoming path backward, passes through the optical-axis aligning means, is incident on a photo-detector, and converted thereby into an electrical signal. The optical-axis aligning means is structured such that one kind of dielectric multilayer film is formed on a transparent substrate, a transparent plate is attached on the one kind of dielectric multilayer film, and that another kind of dielectric multilayer film is formed on the transparent plate, and has its reflectance varied according to the wavelength of the laser beam.

### BACKGROUND OF THE INVENTION

1. Field of the Invention

The present invention relates to an optical pickup apparatus for recording and reading information on recording media (hereinafter referred to as “optical pickup apparatus”), more particularly to an optical pickup apparatus which uses a multi-beam semiconductor laser and is capable of recording and reading compatibly on recording media having respective different recording densities.

2. Description of the Related Art

In an optical pickup apparatus using light, such as CD (compact disk) drive, information is read such that a recording pit is produced by converging light emitted from a laser beam source, as a micro spot, on a track provided on a disk-like recording medium such as a CD, presence or absence of the pit is recorded as information, and the presence or absence of the pit on the track is detected by means of reflected light from the track.

Recently, DVDs (digital video disks), which have a recording capacity about 7 times as large as that of CDs, are becoming remarkably popular along with the growing demand for an increased recording capacity. Increase in recording capacity means improvement of the recording density, which depends on the number of recording pits formed on a recording medium (hereinafter referred to as “disk”). In DVDs, one way for increasing the recording density is to decrease the size of a recording pit, that is, decrease the diameter of a spot of laser beam radiated on the disk. The size of the micro spot to be radiated on the disk is proportional to the wavelength of the laser beam and is inversely proportional to the numerical aperture of an objective lens. Accordingly, for increasing the recording pit, it is required to shorten the wavelength of the laser beam and to increase the numerical aperture of the objective lens.

However, DVDs are strongly required to be compatible with CDs from the viewpoint of backward compatibility of software. Originally, an optical head device was provided with one laser beam source with a wavelength of 635 to 650 nm and one objective lens having a numerical aperture of about 0.6 for the DVDs and also with another laser beam source with a wavelength of 780 nm and another objective lens having a numerical aperture of about 0.45 for CDs, thereby ensuring the compatibility between the both disks.

However, when the numerical aperture of the objective lens is increased, the convergence state of laser beam deteriorates due to coma aberration with respect to the inclination of the optical disk. Since coma aberration is proportional to the third power of the numerical aperture of the objective lens and to the thickness of the disk substrate, the thickness of the disk substrate of DVDs is designed to be about 0.6 mm, which is half that of CDs.

When the thickness of the substrate deviates from the designed value, spherical aberration occurs at a convergence position of light passing through the inward portion of the objective lens and a convergence position of light passing through the outward portion. Therefore, when CD is read by the objective lens with a numerical aperture of 0.6 optimized to the thickness of the DVD substrate, it is necessary to correct the spherical aberration by limiting the outward luminous flux portion incident on the lens or by slightly diverging the incident angle at the lens. Recently, a special DVD/CD-compatible objective lens which is adaptable to both DVDs and CDs without limiting the luminous flux, has been developed and put in a practical use.

Thus, one objective lens can be used compatibly for the DVD and the CD with the necessary correction of spherical aberration, but two laser beam sources each having a different wavelength from other have to be provided for compatibility with a write-once-read-many CD. This is because a reflective recording layer of the write-once-read-many CD is formed of an organic dye material and thus has a reflection coefficient as low as 6% for laser beam having a wavelength of 635 nm to 650 nm, that is a wavelength appropriate to the DVD.

Thus, since the current DVD optical pickup apparatus is equipped with two laser beam sources respectively with a wavelength of 635 nm to 650 nm for the DVD and a wavelength of 780 nm for the CD, and since laser beams from the two light sources are to be guided to two objective lenses, parts such as a prism, aperture control means, or the like are required for respective laser beams, thereby prohibiting downsizing and cost reduction of the apparatus.

In order to solve the problems described above, an optical pickup apparatus shown in FIG. 5 has been proposed. The conventional optical pickup apparatus will be outlined below.

FIG. 5 shows main parts of the conventional optical pickup apparatus. There are provided laser beam sources 91 and 12 to emit laser beams with a wavelength of 650 nm for the DVD and a wavelength of 780 nm for the CD, respectively, a wavelength selection prism 92 to guide any one of the laser beams along a same optical path, a half mirror 11 to reflect and guide the laser beam toward a reflection mirror 15 and also to pass a reflected laser beam from a disk and make it incident on a photo-detector 90.

There is further provided a collimating lens 13 to collimate the laser beam which is directed thereto by the reflection mirror 15 and then is made incident on an objective lens 16 to converge the incident laser beam onto a disk 18a or 18b. The disk 18a or 18b, that is, DVD or CD is placed on a drive mechanism (not shown), and rotated thereby. The objective lens 16 is the special DVD/CD-compatible objective lens described hereinabove.

The laser beam reflected at the disk 18a or 18b and returning therefrom passes through the half mirror 11, is received by the photo-detector 90, and converted thereat into an electrical signal.

FIGS. 6A to 6C are schematic representations of the wavelength selection prism 92. The wavelength selection prism 92 is provided with an optical path control film 80 having the characteristic as shown in FIG. 6C. The optical path control film 80 characteristically blocks light having a wavelength of 700 nm or below, and transmits light having a wavelength of 750 nm or above. Therefore, while light 81 with a wavelength of 780 nm is not blocked by the optical path control film 80 and thus travels straight therethrough as shown in FIG. 6A, light 82 with a wavelength of 650 nm orthogonal to the light 81 is blocked by the optical path control film 80 and reflected by 90 degrees to be directed along the same optical path as the light 81 as shown in FIG. 6B.

The optical pickup apparatus in FIG. 5 operates as follows. A semiconductor laser (wavelength: 650 nm) 91 for DVDs and a semiconductor laser (wavelength: 780 nm) 12 for CDs as light sources are disposed orthogonal to each other so that respective light beams are guided into the same optical path by the wavelength selection prism 92. The optical axis of the light beams is reflected by 90 degrees by the half mirror 11, and reflected again by 90 degrees by the reflection mirror 15, and any one of the light beams is converted in a parallel pencil by the collimating lens 13. The light beam formed in a parallel pencil passes through the objective lens 16 and is made incident on a recording layer of the disk 18a or 18b.

When reading a DVD, the semiconductor laser 91 for DVDs oscillates and the objective lens 16 is placed at the optical path to converge the light beam onto the disk 18a (DVD). When reading a CD, the semiconductor laser 12 for CDs oscillates and the objective lens 16 is placed at the optical path to converge the light beam onto the disk 18b (CD). The light beam reflected at the disk 18a or 18b starts traveling in the backward direction along the incoming path, passes through the half mirror 11, is directed to the photo-detector 90, and is converted thereat into an electrical signal.

However, the conventional art has a problem in that it requires two semiconductor lasers for laser beams with respective different wavelengths for ensuring the compatibility of DVDs, CDs, and CD-R/RWs (CD Recordable/Re-Writable), and a wavelength selection prism for introducing respective laser beams toward the same optical path, which naturally requires additional components and also more space for the additional components, thereby hindering cost reduction and miniaturization of the apparatus.

### SUMMARY OF THE INVENTION

The present invention has been made in light of the above, and it is an object of the present invention to provide a small, low-profile and simple optical pickup apparatus which can play compatibly recording media such as a DVD, a CD, and a CD-R/RW with different recording densities with one single multi-beam semiconductor laser.

In order to solve the above problems, the optical pickup apparatus according to the present invention employs only one single multi-beam semiconductor laser to emit two laser beams each having a different wavelength from other and is provided with a means to coaxially align the optical axes of the laser beams, thereby rendering the optical pickup apparatus less expensive and smaller. The optical pickup apparatus according to the present invention includes a semiconductor laser for emitting light beams having respective different optical axes and different wavelengths, an optical-axis aligning means for making the different optical axes coaxial with each other, a collimating lens for changing the diffusion angle of the laser beam, an objective lens for converging the laser beam onto one of disks having respective different recording densities, and a photo-detector for detecting a reflected laser beam from the disk.

In the optical pickup apparatus according to the present invention, preferably, the optical-axis aligning means may be placed between the semiconductor laser and the collimating lens.

In the optical pickup apparatus according to the present invention, preferably, the optical-axis aligning means may be a half mirror structured such that one kind of dielectric multilayer film to selectively transmit and reflect the laser beams emitted from the semiconductor laser is formed on a surface of a transparent substrate, a transparent plate is attached on the one kind of dielectric multilayer film, and that another kind of dielectric multilayer film to selectively transmit and reflect the laser beams is formed on the transparent plate, and the one kind of dielectric multilayer film and the another kind of multilayer film may have respective different reflectances in accordance with the laser beams with different wavelengths.

In the optical pickup apparatus according to the present invention, preferably, the transparent plate of the optical-axis aligning means may have a predetermined thickness such that the laser beams, which have respective different optical axes and different wavelengths, have the respective optical axes aligned coaxial with each other after they are reflected at the one and another kinds of dielectric multilayer films.

In the optical pickup apparatus according to the present invention, preferably, the one kind of dielectric multilayer film may have high transmittance for one laser beam having one wavelength and low transmittance for another laser beam having another wavelength, while the another kind of dielectric multilayer film may have low transmittance for the one laser beam and high transmittance for the another laser beam.

In the optical pickup apparatus according to the present invention, preferably, the one kind of dielectric multilayer film of the optical-axis aligning means may have low transmittance for the one laser beam and high transmittance for the another laser beam, while the another kind of dielectric multilayer film may have high transmittance for the one laser beam and low transmittance for the another laser beam.

In the optical pickup apparatus according to the present invention, preferably, it may be that the one wavelength of the one laser beam ranges 635 to 650 nm, and the another wavelength of the another laser beam is 780 nm.

### BRIEF DESCRIPTION OF THE DRAWINGS

FIG. 1 is a diagram showing an embodiment of the present invention;

FIG. 2A is a diagram showing a first embodiment of an optical-axis aligning means of the present invention;

FIG. 2B is a diagram showing a second embodiment of the optical-axis aligning means of the present invention;

FIG. 3A shows characteristics of a second dielectric multilayer film 2A provided on the optical-axis aligning means 2;

FIG. 3B shows characteristics of a first dielectric multilayer film 2B provided on the optical-axis aligning means 2;

FIGS. 4A and 4B are schematic representations of optical paths by the first embodiment of the optical-axis aligning means;

FIGS. 4C and 4D are schematic representations of optical paths by the second embodiment of the optical-axis aligning means;

FIG. 5 is a diagram showing main parts of a conventional apparatus; and

FIGS. 6A, 6B and 6C are diagrams and characteristics explaining a conventional wavelength selection prism.

### DESCRIPTION OF THE PREFERRED EMBODIMENTS

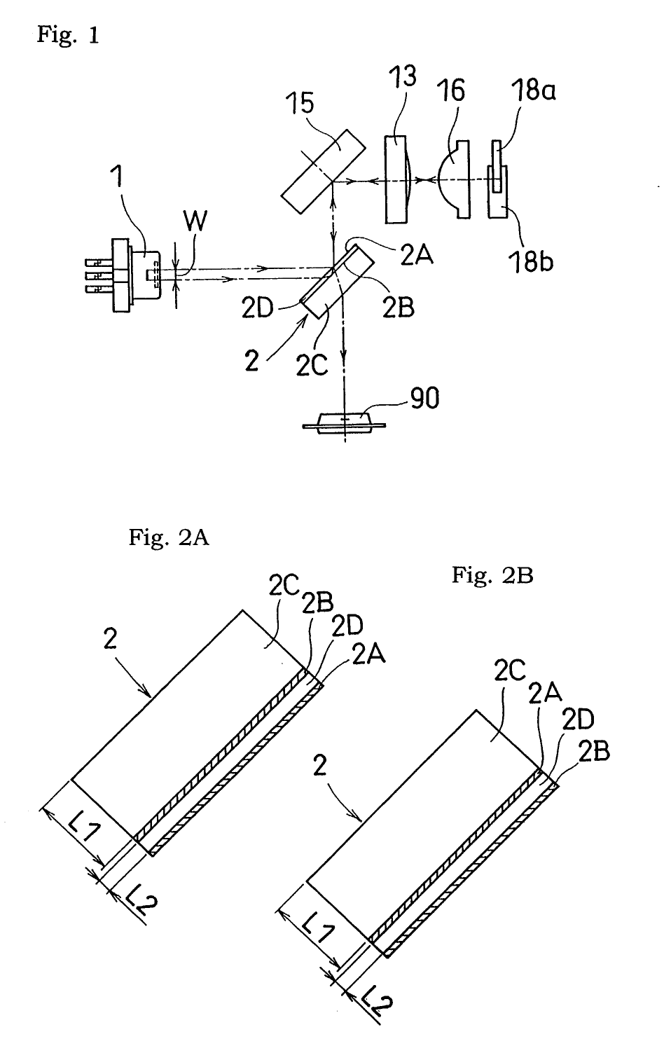

An embodiment of the present invention in FIG. 1 includes a multi-beam laser source 1 which can emit two laser beams having a wavelength λ1 (650 nm) for a high-density disk 18a and a wavelength λ2 (780 nm) for a low-density disk 18b, respectively, and having respective optical axes approximately parallel to each other. The distance W between the respective optical axes is about 100 μm. Further included are an optical-axis aligning means 2 adapted to reflect and make respective laser beam coaxial with each other to one same optical path, a reflecting mirror 15 to direct the laser beam from the optical-axis aligning means 2 toward the disk 18a or 18b, a collimating lens 13 to change the diffusion angle of the laser beam, an objective lens 16 to converge the laser beam from the collimating lens 13 onto the disk 18a or 18b, and a photo-detector 90.

The optical-axis aligning means 2 is placed between the laser beam source 1 and the collimating lens 13, has a structure and characteristics as described later, aligns the respective optical axes of the two laser beams with different wavelengths emitted from the laser beam source 1, and guides to the collimating lens 13. The disk 18a or 18b is mounted on a drive mechanism (not shown), and rotated thereby. The laser beam reflected at a recording surface of the disk 18a or 18b starts traveling backward along the incoming path, is made incident on the optical-axis aligning means 2, passes therethrough, is received by the photo-detector 90, and converted thereby into an electrical signal.

When recording the signal on the disk, the intensity of the laser beam is increased to a predetermined value, and when reading the information on the disk, the intensity of the laser beam is decreased to a predetermined value. These operations are performed by a control circuit and a laser driving circuit (both circuits not shown).

The objective lens 16 is a specialized DVD/CD compatible objective lens, and can converge any one of the two laser beams onto the recording surface of the disks 18a or 18b without coma aberration. The laser beams respectively with the wavelength λ1 (635 to 650 nm) and the wavelength λ2 (780 nm) emitted from the laser beam source 1 are switched over by a control circuit (not shown) as necessary. The reflecting mirror 15 is not an essential optical part and may not necessarily be employed in an optical system.

FIGS. 2A and 2B respectively show first and second embodiments of the optical-axis aligning means 2, which is a half mirror comprising two kinds of dielectric multilayer films. The first embodiment is structured such that a first dielectric multilayer film 2B is formed on the surface of a transparent substrate (for example, optical glass BK7) 2C, a transparent plate (for example, optical glass BK7) 2D is attached on the first dielectric multilayer film 2B, and that a second dielectric multilayer film 2A is formed on the plate 2D. The second embodiment is structured such that a second dielectric multilayer film 2A is formed on the surface of a transparent substrate 2C, a transparent plate 2D is attached on the second dielectric multilayer film 2A, and that a first dielectric multilayer film 2B is formed on the plate 2D.

A thickness L1 of the transparent substrate 2C in FIGS. 2A and 2B is determined by an optical system and an optical path length, and measures, for example, 1.85 mm in this embodiment. The substrate 2C is made of an optical glass (BK7) having refraction indexes of 1.51072 and 1.51405 for the wavelengths λ1 (635 to 650 nm band) and λ2 nm band), respectively, in this embodiment. The plate 2D placed between the first and second dielectric multilayer films 2B and 2A is also of an optical glass BK7, and has a thickness L2 of, for example, about 0.15 mm in this embodiment. The thickness L2 of the plate 2D is determined such that the optical axis of one laser beam having the wavelength λ1 and reflected by the second dielectric multilayer film 2A is aligned coaxial with the optical axis of the other laser beam having the wavelength λ2 and reflected by the first dielectric multilayer film 2B. The thickness L2 depends on an interval W (approximately 100 μm in this embodiment) between the optical axes of the two laser beams emitted from the laser beam source 1 and having respective wavelengths, and on the respective wavelengths, and is about 0.15 mm in the first embodiment of the present invention as described above. The first and second dielectric multilayer films 2B and 2A each have a thickness of as small as several μm, which may be negligible for the thickness of the plate 2D, that is about 0.15 mm. The first and second dielectric multilayer films 2B and 2A are formed on both surfaces of the plate 2D, respectively, and one of the dielectric multilayer films is attached to one surface of the substrate 2C with an optical adhesive.

The half mirror may alternatively be processed such that the first dielectric multilayer film 2B is formed on one surface of the transparent substrate 2C, and the second dielectric multilayer film 2A is formed on one surface of the transparent plate 2D, then the substrate 2C and the plate 2D are attached to each other with an optical adhesive. In this case, the first dielectric multilayer film 2B formed on the substrate 2C is attached to a surface of the plate 2D, on which the second dielectric multilayer film 2A is not formed. Here, the total of the thickness of the optical adhesive and the thickness of the plate 2D constitutes the thickness L2. Also, the first and second dielectric multilayer films 2B and 2A may interchange each other as shown in FIGS. 2A and 2B.

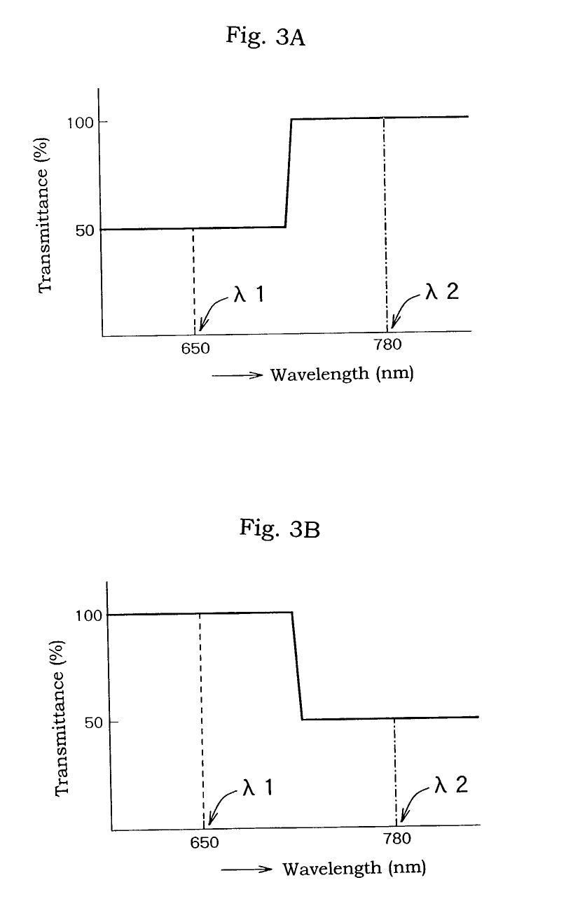

Referring to FIGS. 3A, the second dielectric multilayer film 2A has low transmittance for the first wavelength λ1 (635 to 650 nm) and high transmittance for the second wavelength λ2 (780 nm). Referring to FIG. 3B, the first dielectric multilayer film 2B has high transmittance for the first wavelength λ1 and low transmittance for the second wavelength λ2.

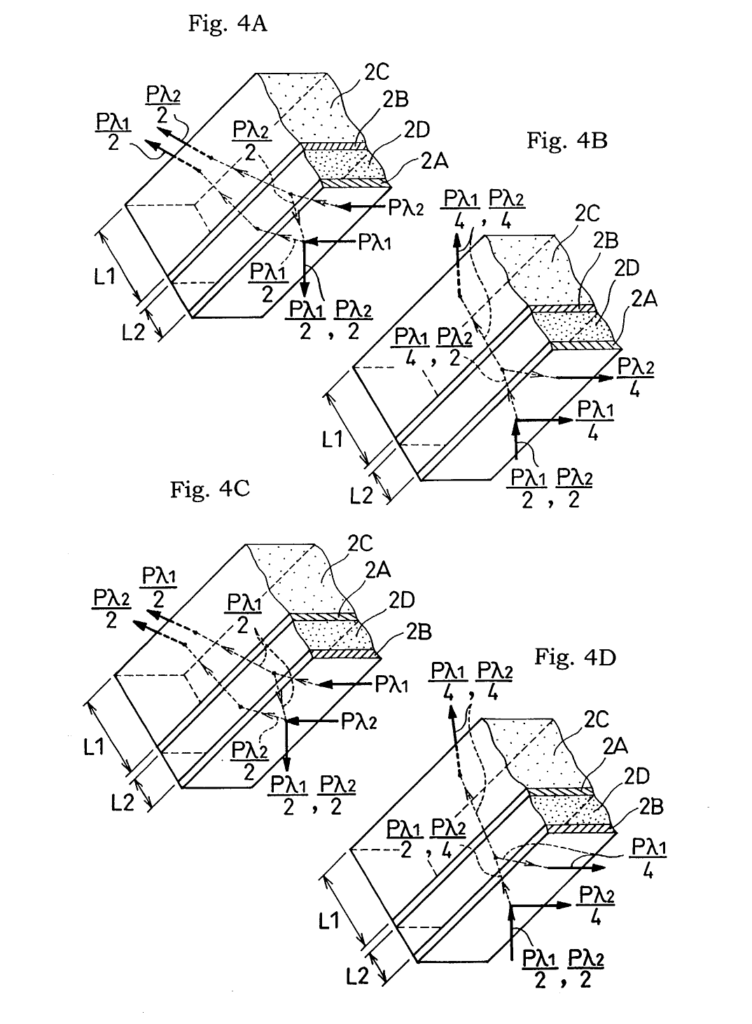

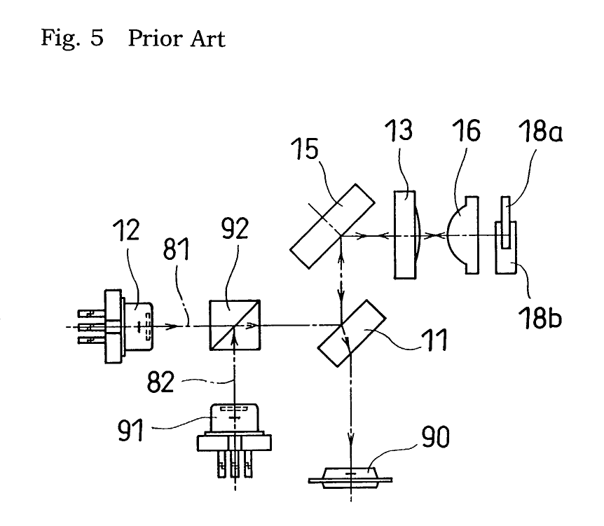

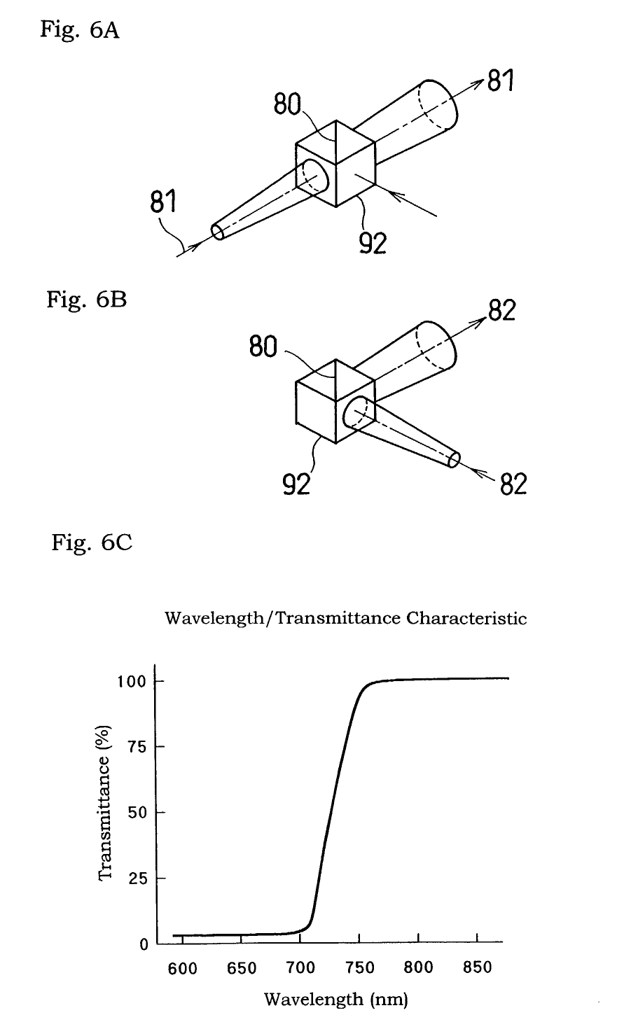

Optical paths in the first embodiment of the optical-axis aligning means 2 will be described with reference to FIGS. 4A and 4B. FIG. 4A shows optical paths of laser beams Pλ1 and Pλ2 with respective optical axes incident on the optical-axis aligning means 2. FIG. 4B shows optical paths of the laser beams Pλ1 and Pλ2 reflected at the recording surfaces of the high-density disk 18a and the low-density disk 18b, respectively, and incident on the optical-axis aligning means 2.

Referring to FIG. 4A, the laser beams Pλ1 and Pλ2 having different optical axes and wavelengths λ1 and λ2, respectively, are incident on the second dielectric multilayer film 2A. Since the second dielectric multilayer film 2A has low transmittance for the laser beam having the wavelength λ1 as shown in FIG. 3A, one half Pλ1/2 of the laser beam Pλ1 with the wavelength λ1 is reflected at the second dielectric multilayer film 2A, and the other half Pλ1/2 passes therethrough. On the other hand, since the second dielectric multilayer film 2A has high transmittance for the laser beam having the wavelength λ2, the laser beam Pλ2 with the wavelength λ2 passes entirely through the second dielectric multilayer film 2A, passes through the transparent plate 2D and is incident on the first dielectric multilayer film 2B.

Since the first dielectric multilayer film 2B has high transmittance for the laser beam having the wavelength λ1 as shown in FIG. 3B, the laser beam Pλ1 passes entirely through the first dielectric multilayer film 2B. On the other hand, since the first dielectric multilayer film 2B has low transmittance for the laser beam with the wavelength λ2, one half Pλ2/2 of the laser beam Pλ2 passes through the first dielectric multilayer film 2B, and the other half Pλ2/2 is reflected thereat. The laser beams Pλ1/2 and Pλ2/2 with respective wavelengths λ1 and λ2, which have passed through the first dielectric multilayer film 2B, pass through the transparent substrate 2C and exit out as stray light.

The laser beams with respective wavelengths λ1 and λ2 reflected at the recording surfaces of the high-density disk 18a and the low-density disk 18b will be described with reference to FIG. 4B. The laser beams Pλ1/2 and Pλ2/2 having respective wavelengths λ1 and λ2 and reflected respectively at the recording surfaces of the disks 18a and 18b are incident on the second dielectric multilayer film 2A. Here, it is assumed that a loss is not caused due to reflection.

Since the second dielectric multilayer film 2A has low transmittance for the laser beam with the wavelength λ1 as shown in FIG. 3A, one half Pλ1/4 of the laser beam Pλ1/2 is reflected at the second dielectric multilayer film 2A, and the other half Pλ1/4 passes therethrough. On the other hand, since the second dielectric multilayer film 2A has high transmittance for the laser beam with the wavelength λ2, the laser beam Pλ2/2 passes entirely through the second dielectric multilayer film 2A. The laser beams Pλ1/4 and Pλ2/2, which have passed through the second dielectric multilayer film 2A, pass through the plate 2D and are incident on the first dielectric multilayer film 2B.

Since the first dielectric multilayer film 2B has high transmittance for the laser beam with the wavelength λ1 as shown in FIG. 3B, the laser beam Pλ1/4 passes entirely through the first dielectric multilayer film 2B. On the other hand, since the first dielectric multilayer film 2B has low transmittance for the laser beam with the wavelength λ2, one half Pλ2/4 of the laser beam Pλ2/2 passes through the first dielectric multilayer film 2B and other half Pλ2/4 is reflected thereat.

The laser beams Pλ1/4 and Pλ2/4 with respective wavelengths λ1 and λ2, which have passed through the first dielectric multilayer film 2B, pass through the substrate 2C coaxially with each other and exit out. The outgoing laser beams with the wavelengths λ1 and λ2, respectively, are converted into respective electrical signals by the photo-detector 90 (shown in FIG. 1) provided on the same optical axis as the laser beams.

Next, optical paths in the second embodiment of the optical-axis aligning means 2 will be described with reference to FIGS. 4C and 4D. FIG. 4C shows optical paths of the laser beams Pλ1 and Pλ2 with respective optical axes incident on the optical-axis aligning means 2. FIG. 4D shows optical paths of the laser beams Pλ1/2 and Pλ2/2 reflected at the recording surfaces of the disks 18a and 18b, respectively, and incident on the optical-axis aligning means 2.

Referring to FIG. 4C, the laser beams Pλ1 and Pλ2 having different optical axes and wavelengths λ1 and λ2, respectively, are incident on the first dielectric multilayer film 2B. Since the first dielectric multilayer film 2B has low transmittance for the laser beam with the wavelength λ2 as shown in FIG. 3B, one half Pλ2/2 of the laser beam Pλ2 is reflected at the first dielectric multilayer film 2B and the other half Pλ2/2 passes therethrough. On the other hand, since the first dielectric multilayer film 2B has high transmittance for the laser beam with the wavelength λ1, the laser beam Pλ1 passes entirely through the first dielectric multilayer film 2B. The laser beams Pλ2/2 and Pλ1, which have passed through the first dielectric multilayer film 2B, pass through the plate 2D and are incident on the second dielectric multilayer film 2A.

Since the second dielectric multilayer film 2A has high transmittance for the laser beam with the wavelength λ2 as shown in FIG. 3A, the laser beam Pλ2/2 passes entirely through the second dielectric multilayer film 2A. On the other hand, since the second dielectric multilayer film 2A has low transmittance for the laser beam with the wavelength λ1, one half Pλ1/2 of the laser beam Pλ1 passes through the second dielectric multilayer film 2A and the other half Pλ1/2 is reflected thereat. The thickness L2 of the plate 2D is determined in the same manner as the first embodiment such that the reflected laser beam Pλ1/2 has a coaxial axis with the laser beam Pλ2/2 reflected by the first dielectric multilayer film 2B. The laser beams Pλ1/2 and Pλ2/2, which have passed through the second dielectric multilayer film 2A, pass through the substrate 2C and exit out as stray light.

The laser beams with respective wavelengths λ1 and λ2 reflected at the recording surfaces of the disks 18a and 18b will be described with reference to FIG. 4D. The laser beams Pλ1/2 and Pλ2/2 having respective wavelengths λ1 and λ2 and reflected respectively at the recording surfaces of the disks 18a and 18b are incident on the first dielectric multilayer film 2B. Here, it is assumed that a loss is not caused due to reflection.

Since the first dielectric multilayer film 2B has low transmittance for the laser beam with the wavelength λ2 as shown in FIG. 3B, one half Pλ2/4 of the laser beam Pλ2/2 is reflected at the first dielectric multilayer film 2B and the other half Pλ2/4 passes therethrough. On the other hand, since the first dielectric multilayer film 2B has high transmittance for the laser beam with the wavelength λ1, the laser beam Pλ1/2 passes entirely through the first dielectric multilayer film 2B. The laser beams Pλ2/4 and Pλ1/2, which have passed through the first dielectric multilayer film 2B, pass through the plate 2D and are incident on the second dielectric multilayer film 2A.

Since the second dielectric multilayer film 2A has high transmittance for the laser beam with the wavelength λ2 as shown in FIG. 3A, the laser beam Pλ2/4 passes entirely through the second dielectric multilayer film 2A. On the other hand, since the second dielectric multilayer film 2A has low transmittance for the laser beam with the wavelength λ1, one half Pλ1/4 of the laser beam Pλ1/2 passes through the second dielectric multilayer film 2A and the other half Pλ1/4 is reflected thereat.

The laser beams Pλ1/4 and Pλ2/4 with respective wavelengths λ1 and λ2, which passed through the second dielectric multilayer film 2A, pass through the substrate 2C coaxially with each other and exit out. The outgoing laser beams Pλ1/4 and Pλ2/4 are converted into respective electrical signals by the photo-detector 90 (shown in FIG. 1) provided on the same optical axis as the laser beams.

In the embodiments according to the present invention, a single semiconductor laser emits two laser beams having respective wavelengths different from each other, and two kinds of dielectric multilayer films selectively transmit and reflect the two laser beams based on the wavelengths. Alternatively, one semiconductor laser may emit three or more laser beams with respective wavelengths different from one another, and three or more kinds of dielectric multilayer films may selectively transmit and reflect the three or more laser beams based on the wavelengths.

Furthermore, a plurality of semiconductor lasers may emit respective laser beams each having a wavelength different from others, and plural kinds of dielectric multilayer films may selectively transmit and reflect the laser beams based on the wavelengths. In this case, intervals between the dielectric multilayer films are varied in accordance with intervals between the semiconductor lasers so that the optical axes of the plurality of semiconductor lasers are aligned coaxial with one another. The semiconductor lasers are switched over as required by a control circuit with the intensity controlled.

In the optical pickup apparatus according to the first aspect of the present invention, since only one semiconductor laser, instead of two, is required for emitting two laser beams with different wavelengths, and since a wavelength selection prism adapted to guide the two laser beams to one same optical path for ensuring compatibility among a DVD, a CD, and a CD-R/RW is not required, a reduced number of components are employed thereby rendering the apparatus less expensive and smaller.

In the optical pickup apparatus according to the second aspect of the present invention, its optical system can be designed simple.

In the optical pickup apparatus according to the fourth aspect of the present invention, the laser beams with different optical axes and wavelengths have their optical axes coaxially aligned with a simple structure.

In the optical pickup apparatus according to the third, fifth and sixth aspects of the present invention, the two kinds of dielectric multilayer films are formed individually, whereby the films can be arbitrarily positioned relaxing the restriction in the formation.

In the optical pickup apparatus according to the seventh aspect of the present invention, the prescribed wavelengths of the laser beams from the semiconductor laser contribute toward making the apparatus less expensive and downsized.

What is claimed is:

1. An optical pickup apparatus for recording and reading information on recording media, the optical pickup apparatus comprising:
a semiconductor laser for emitting laser beams having respective different optical axes and respective different wavelengths;
an optical-axis aligning means, the optical-axis aligning means adapted to coaxially align the respective different optical axes of the laser beams;
a collimating lens for changing a diffusion angle of the laser beam emitted from the semiconductor laser;
an objective lens for focusing the laser beam having passed through the collimating lens onto one of recording media having respective different recording densities; and
a photo-detector for detecting the laser beam reflected at the one of the recording media.

2. An optical pickup apparatus according to claim 1,
wherein the optical-axis aligning means is arranged between the semiconductor laser and the collimating lens.

3. An optical pickup apparatus according to claim 1 or 2,
wherein the optical-axis aligning means is a half mirror structured such that one kind of dielectric multilayer film to selectively transmit and reflect the laser beams emitted from the semiconductor laser is formed on a surface of a transparent substrate, a transparent plate is attached on the one kind of dielectric multilayer film, and that another kind of dielectric multilayer film to selectively transmit and reflect the laser beams is formed on the transparent plate, and
wherein the one kind of dielectric multilayer film and the another kind of multilayer film have respective different reflectances in accordance with the laser beams with different wavelengths.

4. An optical pickup apparatus according to claim 3,
wherein the transparent plate in the optical-axis aligning means has a predetermined thickness such that the laser beams, which have respective different optical axes and different wavelengths, have the respective optical axes aligned coaxial with each other after they are reflected at the one and another kinds of dielectric multilayer films.

5. An optical pickup apparatus according to claim 3 or 4,
wherein the one kind of dielectric multilayer film has high transmittance for one laser beam having one wavelength and low transmittance for another laser beam having another wavelength, while the another kind of dielectric multilayer film has low transmittance for the one laser beam and high transmittance for the another laser beam.

6. An optical pickup apparatus according to claim 3 or 4,
wherein the one kind of dielectric multilayer film has low transmittance for one laser beam having one wavelength and high transmittance for another laser beam having another wavelength, while the another kind of dielectric multilayer film has high transmittance for the one laser beam and low transmittance for the another laser beam.

7. An optical pickup apparatus according to claim 5 or 6,
wherein the one wavelength of the one laser beam ranges from 635 to 650 nm, and the another wavelength of the another laser beam is 780 nm.
